(19) United States
(12) Patent Application Publication
(10) Pub. No.: US 2010/0131675 A1
(43) Pub. Date: May 27, 2010

(54) SYSTEM AND METHOD FOR SECURED DISTRIBUTION OF MEDIA ASSETS FROM A MEDIA SERVER TO CLIENT DEVICES

(76) Inventor: Yang Pan, (US)

Correspondence Address: Yang Pan;Intellectual Power Pte Ltd, No. 14 Robinson Road #06-01,, Far East Finance Building, Singapore, 048545, SG

(21) Appl. No.: 12/277,105

(22) Filed: Nov. 24, 2008

(51) Int. Cl. G06F 15/173

(52) U.S. Cl. 709/247

(57) ABSTRACT

At least one media server and one media client device form an ad hoc wireless communication link or network. The invention is characterized by a method that a media asset in a compressed format is broadcasted over the network while the media asset in an uncompressed format is being played by the server. In accordance with one embodiment, a media file for a song is being played by a HiFi audio system while the file is compressed to MP3 format and is transmitted to a handheld media player through a wireless link. The compressed file may be transmitted repeatedly during the playback cycle of the server. In accordance with another embodiment, a video file is shown on a television terminal while the file is compressed to the MP4 format by a set top box. The MP4 formatted file is transmitted to an ad hoc wireless network including one or a plurality of handheld media players. In accordance with yet another embodiment, a media file for a movie is divided into multiple data packets and is compressed to MP4 format while the file in an uncompressed format is shown in a movie theater. The compressed data packets are transmitted to handheld media players carried by audiences. In all above mentioned embodiments, the media files may be encrypted based on a public key from a public/private key system before the transmission. The received media asset may be decrypted by using a private key after a purchasing operation is completed. The purchasing may be accomplished via an on-line facility.

### CROSS-REFERENCE TO RELATED APPLICATIONS

Not applicable.

### BACKGROUND

1. Field of Invention

This invention relates to a media delivery system, specifically to system and method for secured distributions of media assets from a media server to client devices.

2. Description of Prior Art

Due to the increasing capacity and capability of personal computers, it has become popular to use a personal computer connected to the Internet as a repository for media assets such as for example, songs and multi-media clips. The media assets are typically compressed to a desired format such as MP3 (Motion Picture Expert's Group Layer 3) for songs for digital distribution through the Internet. Handheld media players are used to download media assets from the personal computer. Examples of handheld media players are the iPod from Apple, Inc. of Cupertino, Calif., Zen from Creative Technology Ltd, Singapore and the Zune from Microsoft Inc of Redmond, Wash. The media assets are typically acquired with media management applications, such as iTunes software, which is a product from Apple Inc. The handheld media players have gained popularity due to its capability to store large number of media assets in a device, which can be put into a user's pocket when he or she is moving around.

Downloading compressed media assets from the personal computer to a handheld media player may be carried out via a FIREWIRE (IEEE 1394 type of connection). US patent publications 2004/0224638 and 2008/0125031 by Fadell et al. disclose a media player system with wireless communication capabilities to other media devices. US patent application publication 2008/0031210 by Abhishek et al. discloses a portable media player device capable of operating in a wireless network. Neighbor portable media player devices in an ad hoc network can be discovered by the wireless portable media player device.

There are numerous other existing electronic devices that have been used to deliver media assets to users directly. Examples are high fidelity (HiFi) audio system for music, digital television system with a set top box for video and car media system for radio and music. Although a significant number of media assets are delivered to users via these devices, the opportunities have not been explored for distributing media assets to other media devices. A user, enjoying a song played by a HiFi system, may be motivated to purchase and store the song in his or her handheld media player.

Therefore, what is desired is a media delivery system that leveraging existing media asset delivery devices, such as for example, a HiFi audio system, a digital TV and a car media system to distribute a media asset being broadcasted or being played to other media devices controlled by a user.

### SUMMARY OF THE INVENTION

A media delivery system includes a media server and at least one media client device. The media server may be a conventional media delivery apparatus with an added data compression unit and a wireless communication unit. When a media asset with a data format is being played, the same asset is compressed and is transmitted wirelessly to the client devices. The client device may be a media player with an additional wireless communication capability. A client device or multiple client devices and the server may form a wireless network. The client devices are connected to the server when the devices are in the proximity. The wireless communication network is an ad hoc network.

The client device receives the compressed media asset. According to one implementation of the present invention, the metadata of the asset such as the title and artists of the asset are displayed on a display screen of the client device with an option for the user to purchase the asset. The compressed asset may be encrypted before it is transmitted from the server. The encryption may be based on a public/private key system. A public key is distributed to the server. The asset can be decrypted after the purchasing process is completed and a private key is received. When the client device is connected to the Internet, the purchasing can be conducted through an on-line payment facility.

The invention relates, in one embodiment, to a HiFi audio system with an added data compression unit and a wireless communication unit. According to one implementation, the wireless communication is conforming to the Bluetooth type of standard (IEEE 802.11). When a song is being played in an uncompressed format by the HiFi system, the asset is being compressed to MP3 format and is encrypted and is transmitted wirelessly to client devices. When a user with a handheld media player as the client device approaches the HiFi system as the server, a wireless communication link is established. The handheld media player receives the MP3 formatted song and stores the data in its file storage system. The user will notify that the metadata of the song is displayed on its display screen. A purchase option may be displayed. The option may be with a “yes” or “no” type. The user's selection of “yes” will lead to an on-line payment process if the client device is connected to the Internet. The asset can be decrypted after receiving a private key. The decrypted asset may be stored in the file storage system of the handheld media player.

The invention relates to, in another embodiment, a digital TV with a set top box. When a video programming in an uncompressed format is delivered to the TV terminal for displaying, the file is compressed to MP4 (Moving Picture Experts Group under the formal standard ISO/IEC 14496) and is transmitted wirelessly to MP4 players. The video file in MP4 form may be encrypted before the transmission. The MP4 player receives the video file. A user may decide to purchase the asset. The video file is stored in the file storage system of the MP4 player after the decryption. Some assets may be acquired freely. In such a case, encryption/decryption may not be needed.

Various other embodiments based upon similar inventive concept by using such as a vehicle media system, an advertisement display panel, a theater media system and a concert media recording and processing system as the media server and by using a HiFi audio system and a personal computing device as the client device will be discussed in details in the following sections.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1a is a schematic diagram of a media delivery system including a media server and a media client device. They are connected wirelessly to form an ad hoc network.

FIG. 1b is a schematic diagram of an embodiment of the media delivery system, wherein the media server is based upon a HiFi audio system and the media client device upon a handheld media player.

FIG. 1c is a schematic diagram of an embodiment of the media delivery system, wherein the media server is based upon a digital TV system with a set top box and the media client device upon a handheld media player or a personal computer or a HiFi audio system.

FIG. 1d is a schematic diagram of an embodiment of the media delivery system, wherein the media server is based upon a vehicle media system and the media client device upon a handheld media player.

FIG. 1e is a schematic diagram of an embodiment of the media delivery system, wherein the media server is based upon a handheld media player and the media client device upon another handheld media player.

FIG. 1f is a schematic diagram of an embodiment of the media delivery system, wherein the media server is based upon an electronic advertising display panel and the media client device upon a handheld media player.

FIG. 1g is a schematic diagram of an embodiment of the media delivery system, wherein the media server is based upon a theater audio/video system and the media client device upon a handheld media player.

FIG. 1h is a schematic diagram of an embodiment of the media delivery system, wherein the media server is based upon a concert media recording and processing system and the media client device upon a handheld media player.

FIG. 2 is a schematic functional block of a HiFi audio system as the media server according to one embodiment of the present invention.

FIG. 3 is a schematic functional block of a handheld media player as the media client device according to one embodiment of the present invention.

FIG. 4 shows a representative handheld media player as a media client device. The display screen of the device illustrates that the metadata of the compressed media asset is displayed and an option of purchase is offered to the user by selecting a “yes” or “no” according to one implementation of the present invention.

FIG. 5 shows a flow diagram of the operation that an uncompressed media asset is being played by the media server while the asset is compressed, encrypted and transmitted wirelessly to the media client device.

FIG. 6 shows a flow diagram of the operation that an uncompressed media asset is being played by the media server while the asset is compressed, encrypted and transmitted wirelessly in a repeatedly manner to the media client device.

FIG. 7a shows a schematic diagram of uncompressed and compressed media data is divided into multiple data packets.

FIG. 7b shows a flow diagram of the operation that an uncompressed media asset is being played by the media server while the asset is compressed, encrypted and transmitted wirelessly to the media client device. The compressed asset is divided into multiple data packets which are transmitted sequentially in a synchronized manner as the uncompressed asset is being played.

FIG. 8 shows a flow diagram of the operation that a compressed and encrypted media asset is received by a media client device and is purchased by the user of the client device.

FIG. 9 shows a flow diagram of the payment process of a client device when a media asset is received from the media server.

FIG. 10 shows a flow diagram of the operation of an embodiment of the present invention, wherein the media server is a recording and data processing system for a concert and the media client devices are many handheld media players.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

The term “media player” generally refers to computing devices that are dedicated to processing media such as audio, video or other images, as for example, music players, game players, video players, video recorders, digital cameras, and the like. In some cases, the media players contain single functionality (e.g., a media player dedicated to playing music) and in other cases the media players contain multiple functionality (e.g., a media player that plays music, displays video, stores pictures and the like). In either case, these devices are generally portable so as to allow a user to listen to music, play games or video or take pictures wherever the user travels.

The term “media server” generally refers to computing devices that are used to processing media. It may be a general purpose computer and it may also be a dedicated media player such as a HiFi audio system or a digital television system with a set top box. A media server has a functionality to transmit a media asset to other media devices.

The term “media client device” generally refers to computing devices that receive media assets from media servers. The media client devices are in general media players with the capability to communicate or at least the capability to receive information from the media servers. The media client devices may be portable in some cases. The media client devices may not be portable in other cases.

The term “media asset” generally refers to media files such as text, audio, video, TV programs, images, photos, web pages, multi-media files and the likes. Some media assets may be protected by the copy right. For digital right management purposes, it may be desirable to encrypt the media assets during transmission over a wireless link or a wireless network. A public/private key system as well known in the art may be used.

The term “wireless network” generally refers to computer network that is wireless and is commonly associated with a telecommunication network whose interconnections between nodes is implemented without use of wires. In some implementations, Wireless Personal Area Network (WPAN) is used to connect media servers and media client devices within a relatively small area, generally within reach of a person. For example, the wireless communication network may conform to the Bluetooth type of standard (IEEE 802.11) or to the Zigbee type of standard (IEEE 802.15.4). In other implementations, the wireless network can also take form of a WiFi (IEEE 802.11b or 802.11g) network. Yet in some other implementations, FM, RF, IR (infrared), UWB (ultra wide band, IEEE 802.15.4a) and visible light links may be used to connect the media servers and the media client devices.

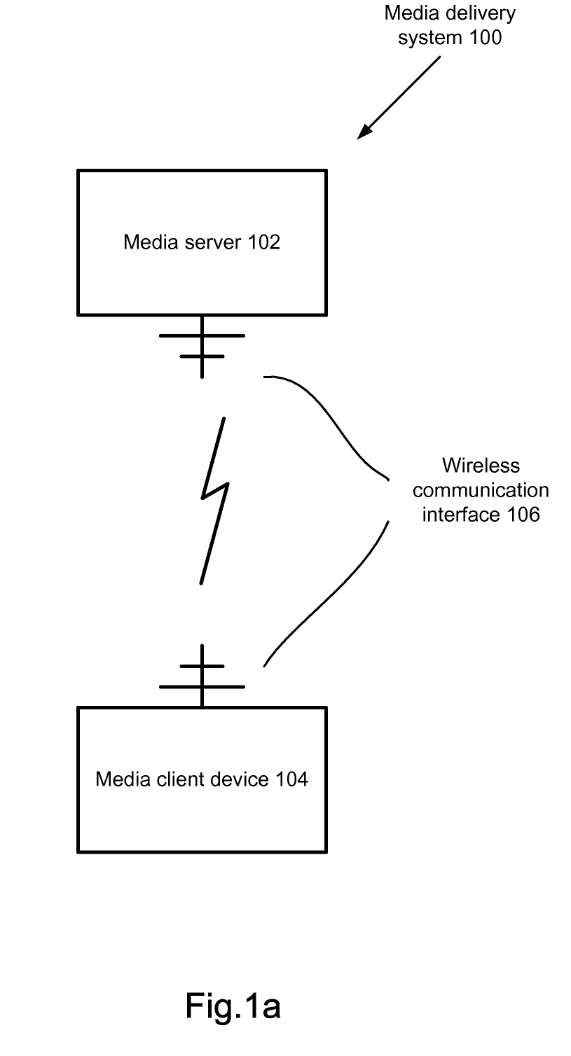

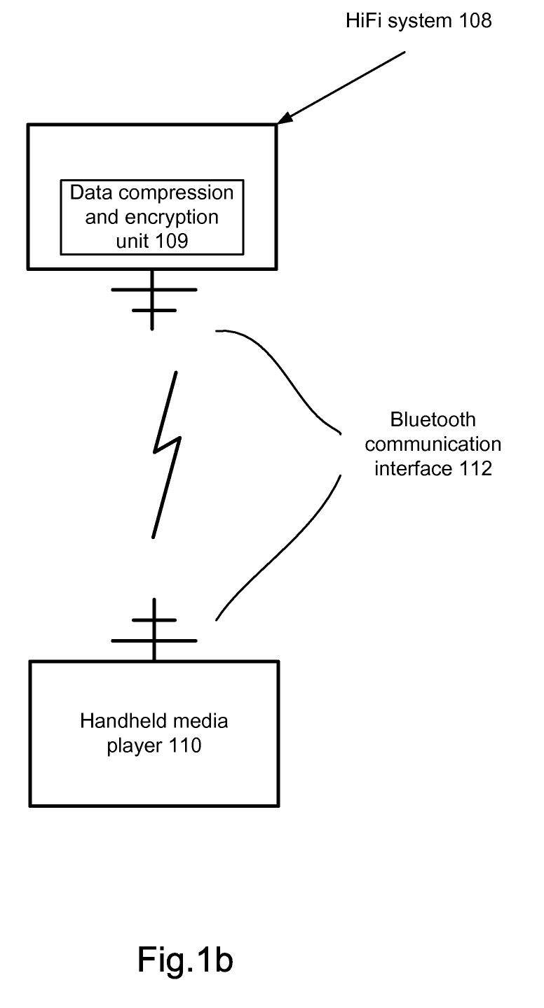

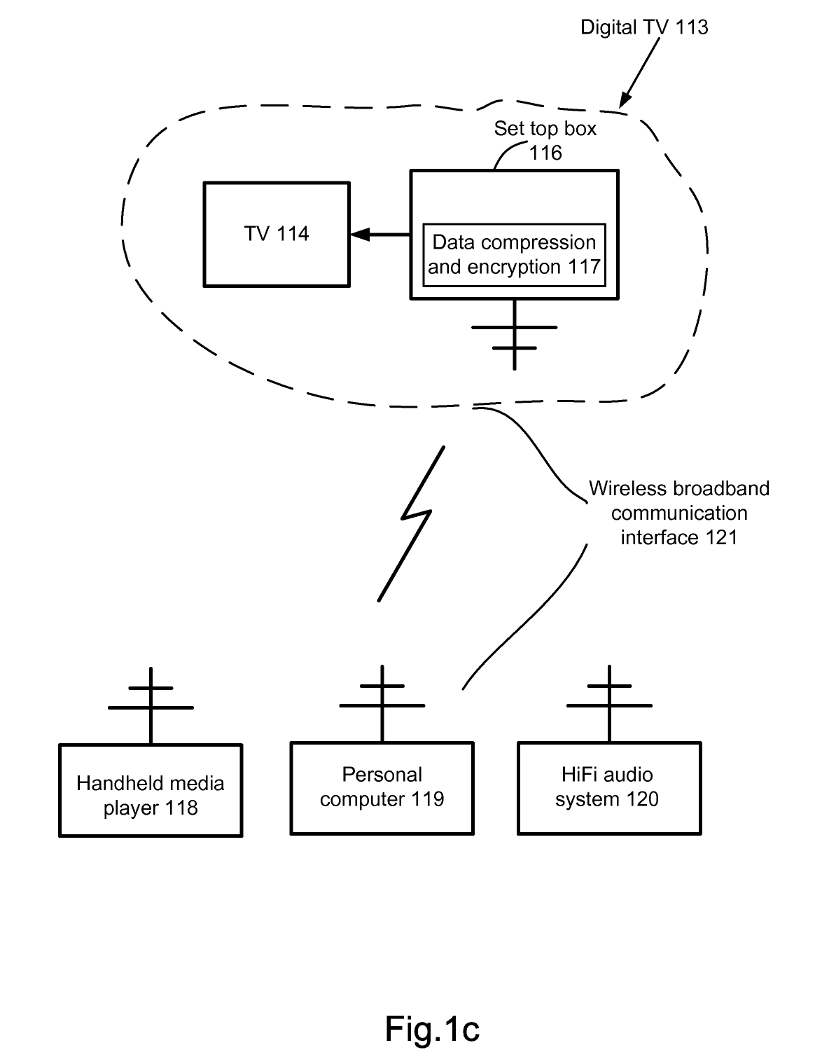

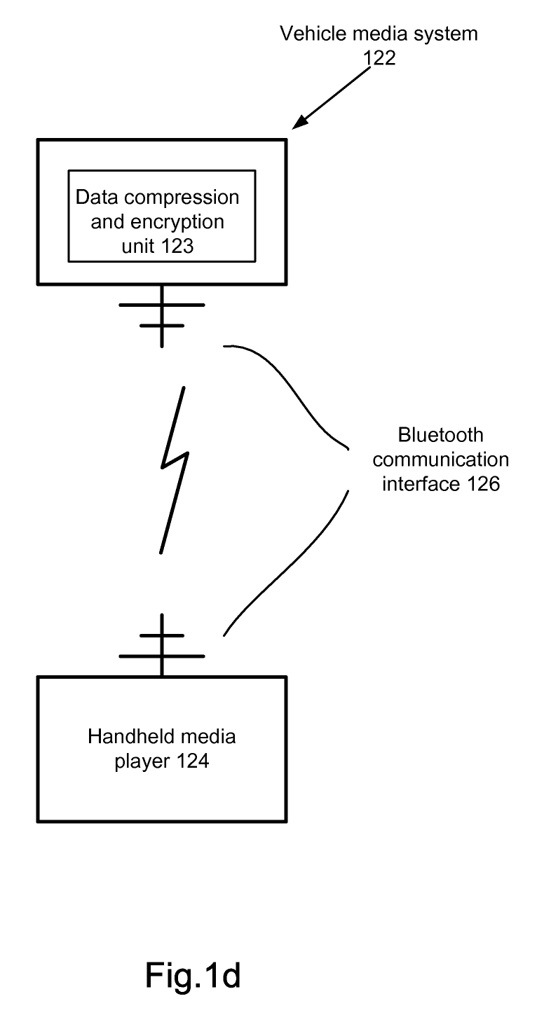

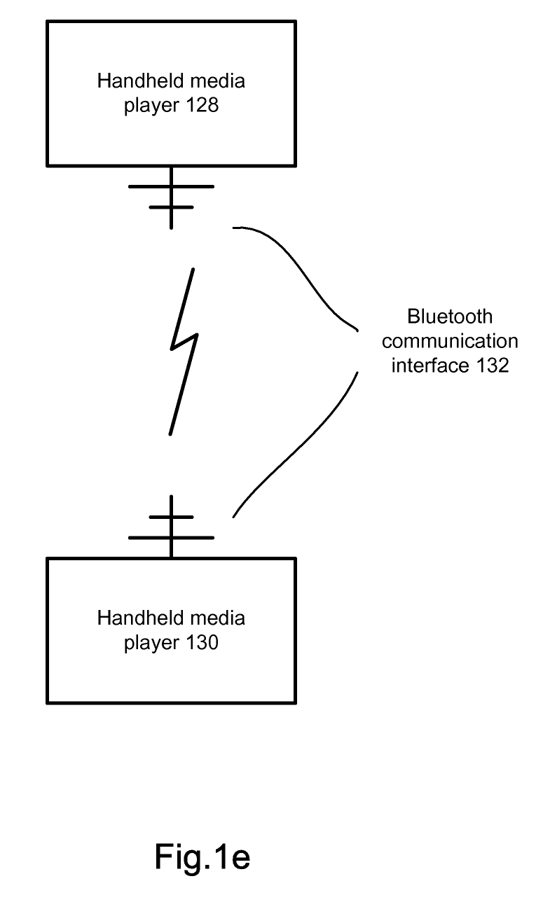

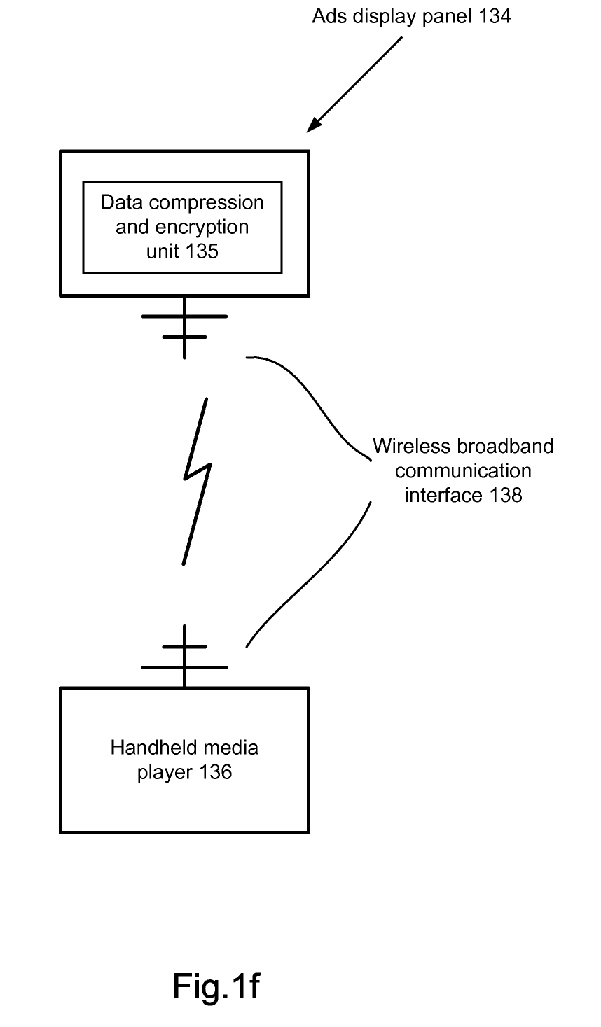

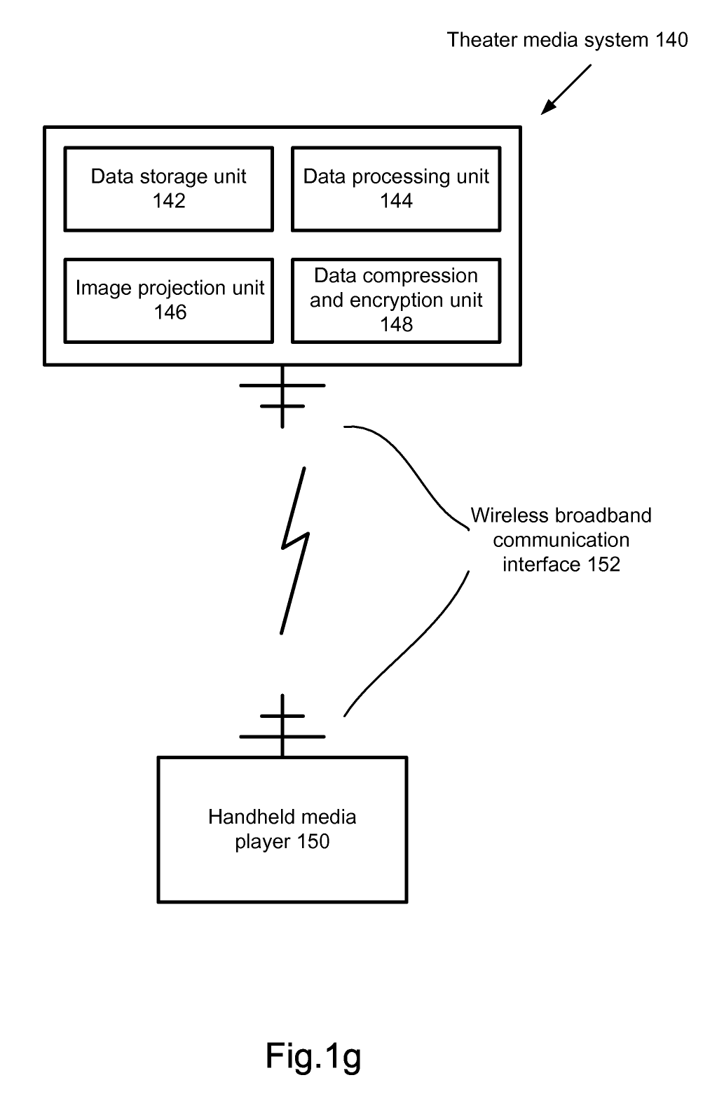

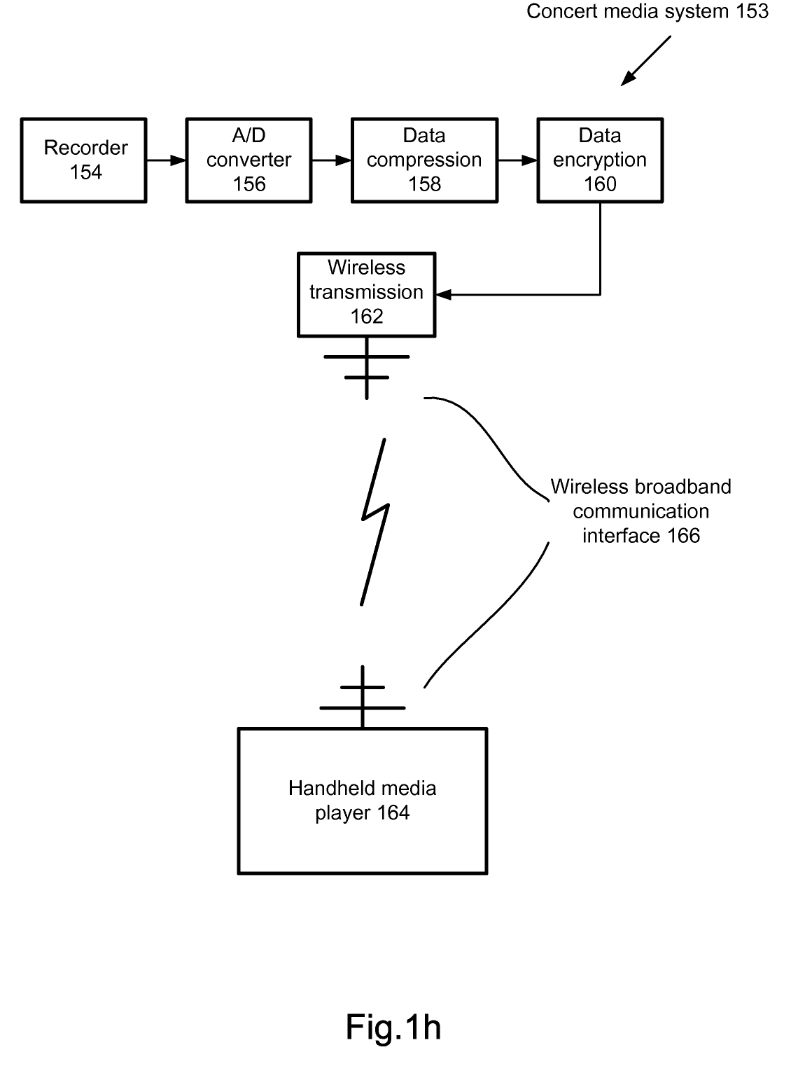

As shown in FIG. 1a, a media delivery system 100 comprises a media server 102 and a media client device 104. The server 102 and the client device 104 are connectable by a wireless communication network interface 106. According to a preferred embodiment, the wireless communication interface conforms to the Bluetooth type of standard (IEEE 802.11). Both the server and the client device may include a transceiver (for two way communications). Alternatively, the server may include a transmitter and the client device may include a receiver (for one way communication). An antenna is required and may be fully contained within the server and the client device.

Although only one server and one client device is shown in the figure, the inventive concept can be extended to multiple servers and multiple client devices. The servers and client devices may form an ad hoc wireless network. The network is the WPAN in a preferred implementation. Both server and client device may also be connected to other communication network such as the Internet. The media server 102 may be used to deliver a media asset to a user directly. The media asset may be in an uncompressed format. The media asset may also be in a compressed format such as MP3 for a song. The present invention is characterized by that the media asset being played by the server and the one being transmitted over the wireless link or network may be in different formats. For example, a media asset in uncompressed format may be played by the server 102 while the asset in the compressed form is being transmitted by the server 102 and being received by the client device 104.

FIG. 1b shows a schematic diagram of one embodiment of the present invention. The media server is based upon a HiFi audio system 108. The system has a data compression and encryption unit 109. The client device 110 is based upon a handheld media player. The HiFi audio system 108 and the handheld media player 110 are connectable via a wireless communication interface 112. The Bluetooth type of communication (IEEE 802.11) a preferred embodiment although other communication links are possible as described previously. Songs are now used as exemplary media assets in the description without limiting the scope of the present invention. The audio data for the song is compressed by a processor in the HiFi audio system before it is encrypted for the transmission. The compressed audio data may take a format of MP3 or other formats as well known in the art. The digital right may be managed by encrypting the compressed audio data. Typically, this requires some forms of authentication, and is preferably based on a public key/private key system. In one embodiment, the audio data is encrypted by a public key before the transmission. The handheld media player 110 (client device) with the Bluetooth communication interface receives the encrypted audio data. The audio data is stored in a file storage system of the handheld media player 110. The metadata is then displayed on a display screen of the player. The user may decide to purchase the asset if it is encrypted or the user may decide to abandon the asset after viewing the metadata. After the user purchases the song, the audio data is decrypted based on a received private key from the on-line merchandiser and is stored in the file storage system for the future usages.

It should be emphasized that when a song is being played by the HiFi audio system 108 in the uncompressed format, the audio data is being compressed to the MP3 format in the same time. The compressed data is encrypted and is transmitted over the wireless link or network. The present invention is characterized by that the audio data being played and the audio data being transmitted may take different formats although they represent the same media asset. The present invention allows that a user favored song is purchased and is stored in the handheld media player conveniently when the user is enjoying a high quality song via the HiFi system.

FIG. 1c shows a schematic diagram of another embodiment of the present invention. The media server is based upon a digital television (TV) system 113 comprising a TV terminal 114 and a set top box 116. The set top box 116 includes a data compression and encryption unit 117. The client device is based upon a handheld media player 118. The digital TV system 113 and the handheld player 118 are connectable through the wireless communication interface 121 as shown in the figure. The communication interface may be a wireless broadband communication protocol such as WiFi (IEEE 802.11b or 802.11g) or UWB (IEEE 802.15.4a) enabling transmitting video data in a reasonable time. The set top box 116 is with a wireless transmitter or a transceiver. The handheld media player 118 is with a wireless receiver or a transceiver. The set top box 116 may also be connected to other communication networks such as the Internet. The handheld media player 118 may also be connected to the Internet directly or through another server such as a general purpose computing device. A video programming transmitted from the set top box 116 is broadcasted in the TV terminal 114. The video file may be compressed by the set top box to a desired format such as MP4. The compressed video programming may be encrypted based on a public/private key system as described previously and be transmitted to the handheld media player 118 wirelessly. The handheld media player 118 receives the video programming in MP4 format and may display its metadata on a display screen of the player. The user may decide to purchase the program and to decrypt the asset based on received private key and store it in the file storage system of the handheld player 118. Some video programs may not be copy right protected. In such a case, the encryption/decryption steps may not be required and the video programming is received and stored in the media client device.

In another implementation of the current embodiment, the client device may be based upon a personal computer 119 as shown in the figure. The compressed video programming may be received by the personal computer 119 and be stored in its memory system. The user may purchase the asset on-line when the personal computer is connected to the Internet. After the purchasing, the programming is decrypted based on the received private key and the user can use it accordingly with a standard MP4 player in the computer.

In yet another implementation of the current embodiment, the client device may be a HiFi audio system 121. The audio portion of a multi-media programming may be compressed and encrypted by the set top box 116 and be received by the HiFi audio system 120 and be stored in its memory system. The user may purchase the asset and decrypt and store it for future usage through using an input device such as a remote control of the HiFi audio system 120.

FIG. 1d is a schematic diagram of another embodiment of the present invention. The media server is a vehicle media system 122. The vehicle media system 122 comprises typically a radio and a music player including a compact disk driver. Some car media systems have been integrated with a plug-in handheld media player such as an iPod from Apple. According to one implementation of the present invention, a data compression and encryption unit 123 is included in the system. The client device is a handheld media player 124. The vehicle media system 122 and the player 124 are connectable through a wireless communication interface 126, which may be conformed to the Bluetooth type of standard (IEEE 802.11) in a preferred embodiment of the present invention. When connected, the vehicle media system 122 and the handheld media players may form a wireless network. Similarly, other wireless communication links or networks as described previously are also possible. When a driver or a passenger carrying a handheld media player 124 in a vehicle, a wireless communication link is established between the vehicle media system 122 and the player 124. When a song as an exemplary case for a media asset is played via the compact disk driver or broadcasted by employing digital broadcast system, the audio data is compressed to MP3 format in a preferred implementation and be encrypted before it is transmitted to the handheld media player 124 through the Bluetooth communication interface 126. The handheld media player 124 receives the song in MP3 format and stores the asset in its file storage system. The user may decide to purchase the asset. The data will be decrypted if the purchasing operation is completed and a private key for decryption has been received.

FIG. 1e is a schematic diagram of another embodiment of the present invention. The media server is based upon a handheld media player 128 and the client device is based upon another handheld media player 130. The media players 128 and 130 are connectable by a wireless communication interface 132, which may conform to the Bluetooth type of standard (IEEE 802.11) in a preferred embodiment. A media asset such as a song being played by the player 128 may be encrypted and be transmitted to the media player 130. After receiving the song in the compressed format such as the MP3, the metadata of the song is displayed on a display screen of the media player 130. The user of 130 may decide to purchase the asset or to abandon the asset. The completion of the purchasing process may lead to the decryption and storage of the asset for further usage. The inventive concept can readily be extended to multiple handheld media players forming an ad hoc wireless network.

FIG. 1f is a schematic diagram of another embodiment of the present invention. The media server is based upon an advertisement panel 134. An advertisement panel may be a computing and communication device which displays advertisement contents. A data compression and encryption unit 135 may be integrated with the panel 134. The client device is based upon a handheld media player 136. When a user carrying the media player (i.e. a MP4 player) 136 is approaching the panel 134, a wireless communication link is established between the panel 134 and the player 136. The wireless communication interface 138 may conform to the Bluetooth type of standard (IEEE 802.11) in a preferred embodiment. A programming being played by the panel may be compressed and transmitted over the link or a network. A user carrying the player 136 may decide to receive the video file for the programming and to store the file in its file storage system of the player 136.

FIG. 1g is a schematic diagram of yet another embodiment of the present invention. The media server is a theater audio/video system 140. The system 140 includes a data storage system 142 for storing movie contents, a data processing unit 144 and an image projection unit 146. It further includes a data compression and encryption unit 148. The client device is a handheld media player 150 carried by an audience. The system 140 and the media player 150 are connectable by a broadband wireless communication interface such as a WiFi (IEEE 802.11b or 802.11g) network 152. When the audience is watching a movie, the video/audio data is compressed to MP4 in a preferred embodiment and the data packets in an encrypted format based on the public/private key system are transmitted over the wireless network and are received by the media players of the audiences. The audiences have a compressed movie in its media player after watching the movie. The data, however, is encrypted. If the user decides to purchase the asset, the asset is decrypted after receiving the private key and is stored in the media player for further usage. The movie content may be divided into multiple sections and an audience may select one or many sections to purchase.

FIG. 1h is a schematic diagram of yet another embodiment of the present invention. The media server is a concert media system 153, which comprises an audio/video recording unit 154, an A/D converter 156, a data compression unit 158 and a data encryption unit 160. The compressed and encrypted media data file representing a live performance is transmitted to handheld media players 164 carried by audiences via the wireless communication device 162. The wireless communication interface 166 between the concert media system 153 and the handheld media player 164 may be a wireless broadband communication network such as a WiFi (IEEE 802.11b or IEEE 802.11g) wireless network. The network is an ad hoc network. The media assets in a desired compressed format such as MP4 produced during the concert are transmitted to the handheld media players 164 in a real time base. The asset is encrypted based on a public/private key system. The audiences may purchase the asset through an on-line facility. Alternatively, the assets may be paid via the entry tickets and the data transmitted is not encrypted and the users may enjoy the compressed assets stored in his or her handheld media player after the concert.

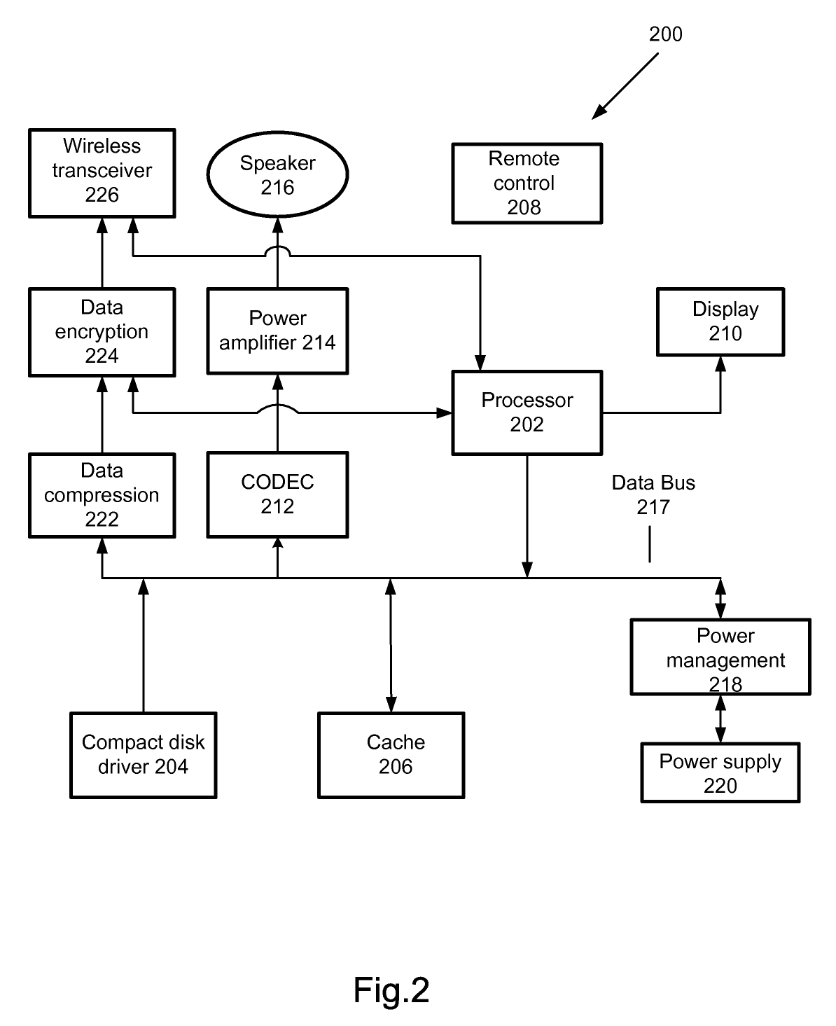

The HiFi system and handheld media player based media delivery system is used herein as an exemplary case to illustrate the inventive concept in detail. FIG. 2 is a schematic functional block of a HiFi audio system 200 used as the media server. The HiFi audio system 200 includes a processor 202 that pertains to a microprocessor or a controller for controlling the overall operation of the system. The audio system 200 includes a compact disk driver 204, which reads out the media asset such as a song or a music clip from the compact disk and converts the assets into digital signals. The audio system 200 stores the digital signals in a cache 206. The cache 206 is, for example, Random-Access Memory (RAM) provided by semiconductor memory.

The audio system 200 also includes a user input device 208 that allows a user to interact with the system. The user input device 208 may be a remote control, which is connected to the media player via an optical or a wireless link as well known in the art. Still further, the audio system 200 includes a display 210 (screen display) that can be controlled by the processor 202 to display information to the user.

When a user desires to have the HiFi system 200 to play a particular media asset such a song from a loaded compact disk, the user can select one of the available media assets by using of the remote control 208. The processor 202, upon receiving a selection of a particular media asset, supplies the media data (e.g., audio file) for the particular media item to a coder/decoder (CODEC) 212. The CODEC 212 then produces analog output signals for a high precision power amplifier 214 and speakers 216.

A data bus 217 can facilitate data transfer between at least the file system 204, the cache 206, the processor 202, and the CODEC 212. The HiFi system 200 is powered by a power supply 220 through power management circuits 218.

According to one implementation of the present invention, the HiFi system 200 further includes a data compression unit 222 and a data encryption unit 224. When an uncompressed media asset is being played, the asset is compressed to a desired format such as MP3. The compressed audio data is then encrypted based on the public/private key system if the user does not own the digital right. The encrypted audio asset is transmitted wirelessly via a transceiver 226. The operation of the transceiver 226 is controlled by the processor 202.

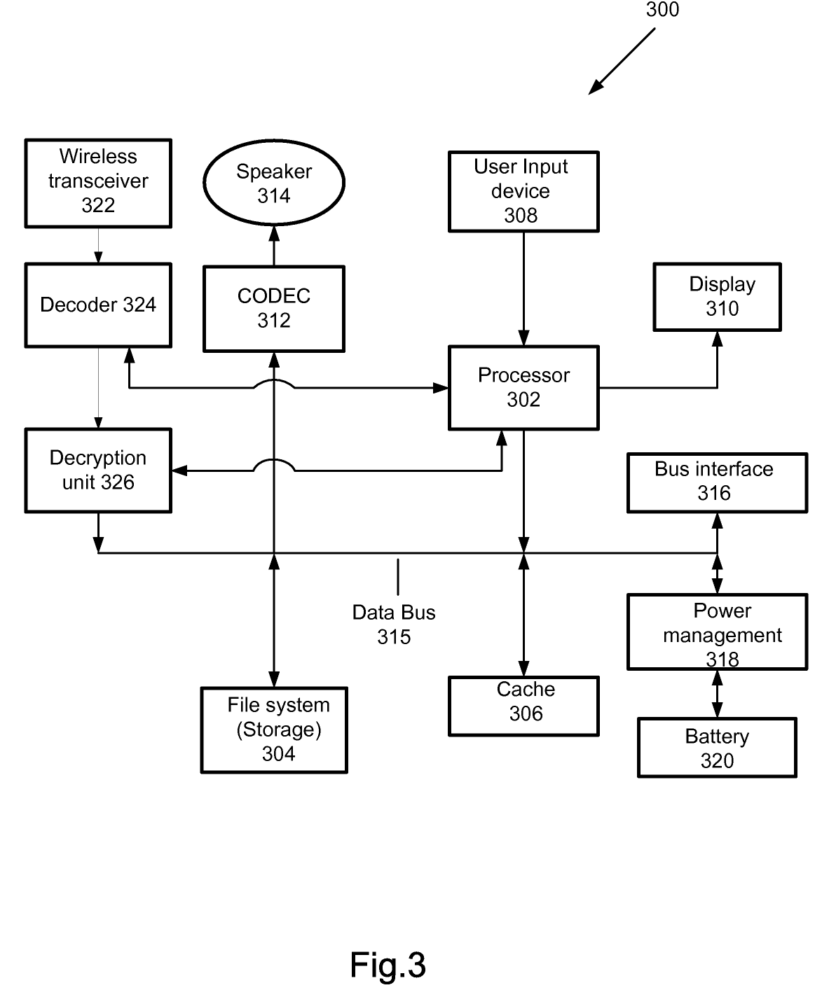

FIG. 3 shows a schematic functional block of a conventional handheld media player 300 as the client device with an integrated wireless communication capability. The media player 300 includes a processor 302 that pertains to a microprocessor or a controller for controlling the overall operation of the media player. The media player 300 stores media data pertaining to media assets in a file system 304 and a cache 306. The file system 304 is, typically, a flash memory or a plurality of flash memories or a storage disk or a plurality of disks. The file system 304 typically provides high capacity storage capability for the media player 300. However, since the access speed to the file system 304 is relatively slow, the media player 300 can also include a cache 306. The cache 306 is, for example, Random-Access Memory (RAM) provided by semiconductor memory. The relative access time to the cache 306 is substantially shorter than for the file system 304. However, the cache 306 does not have the large storage capacity of the file system 304. Further, the file system 304, when active, consumes more power than does the cache 306. The power consumption is particularly important when the media player 300 is a handheld media player that is powered by a battery 320 through power management circuits 318. The media player 300 may also include a RAM and a Read-Only Memory (ROM), which is not shown in the diagram. The ROM can store programs, utilities or processes to be executed in a non-volatile manner. The RAM provides volatile data storage, such as for the cache 306.

The media player 300 also includes a user input device 308 that allows a user of the media player 300 to interact with the player. For example, the user input device 308 can take a variety of forms, such as a button, keypad, dial, etc. Still further, the media player 300 includes a display 310 (screen display) that can be controlled by the processor 302 to display information to the user.

The media player 300 serves to store many media assets (e.g., songs) in the file system 304. When a user desires to have the media player play a particular media asset, a list of available media assets is displayed on the display 310. Then, using the user input device 308, a user can select one of the available media assets. The processor 302, upon receiving a selection of a particular media item, supplies the media data (e.g., audio file) for the particular media asset to a coder/decoder (CODEC) 312. The CODEC 312 then produces analog output signals for speakers 314. A data bus 315 can facilitate data transfer between at least the file system 304, the cache 306, the processor 302, and the CODEC 312. The media player 300 also includes a bus interface 316 that couples to a data link (not shown). The data link allows the media player 300 to couple to a host computer. The media player 300 is powered by a power supply 320 through power management circuits 318.

The media player 300 further includes wireless transceiver 322 for receiving the encrypted and compressed media assets. A decoder 324 is used to decode the received media file. A decryption unit 326 is used to decrypt the decoded data. The decryption unit 326 may not be necessary a piece of hardware and it may be software package controlled by the processor 302 or it may be a combination of the software and hardware implementation. A software module is used to display the metadata of the received asset on the screen of the media player 300. A purchasing option is further displayed on the display 310 of the media player 300. The user's selection of the purchasing of the asset will lead to the media player 300 receiving a decryption key (private key) from an on-line merchandiser to decrypt the data and to store the asset in the file storage system 304 of the media player.

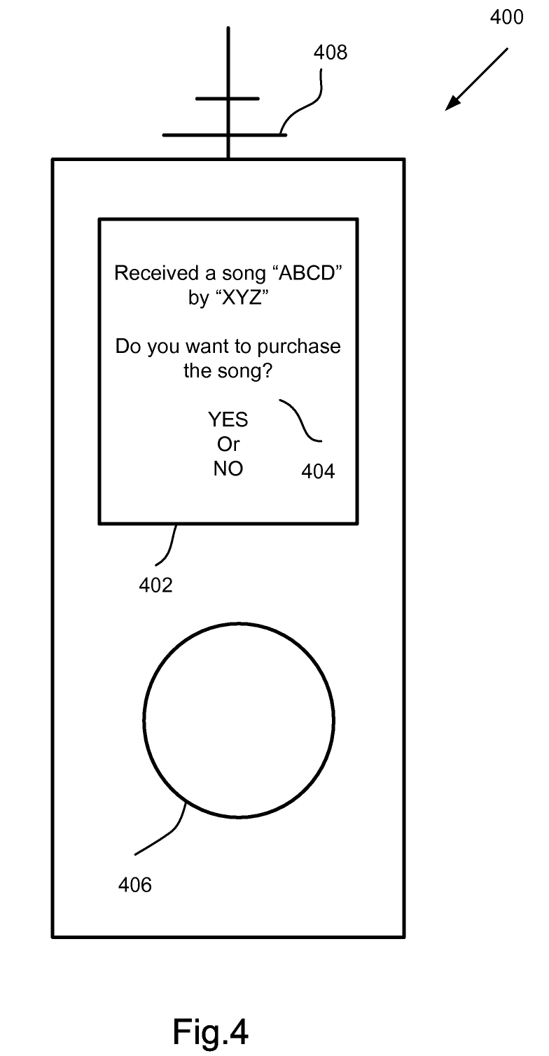

FIG. 4 shows a representative handheld media player 400 as a media client device. The display screen 402 of the device illustrates that the metadata 404 of the compressed media asset is displayed and an option of purchase is offered to the user by selecting a “yes” or “no” according to one implementation of the present invention. If the display is a touch-screen type of device, the user may use his or her fingers or a stylus to make the selection. Alternatively, the user may move the cursor to locate the selection and actuate the selection button or pad accordingly. The media player has a user interface 406 which may be a rotational user interface as used in some of iPods from Apple and a wireless communication network interface 408 is also shown in the figure.

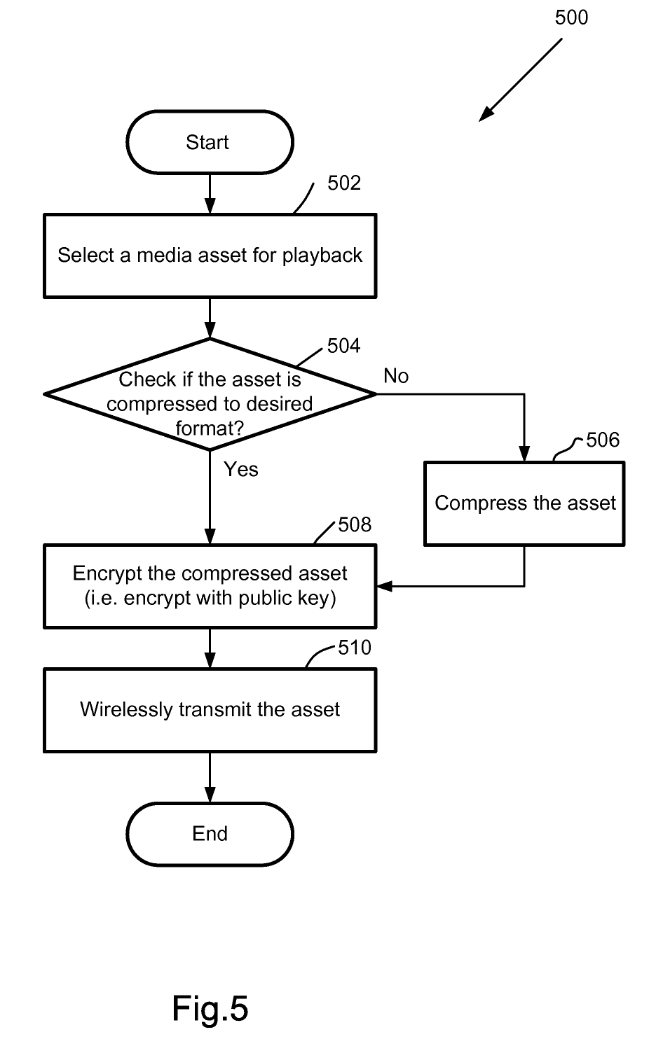

FIG. 5 shows a flow diagram of a process 500 that a media asset is transmitted from a media server 102 to the media client device 104 as shown in FIG. 1a. The process is characterized by that a media asset in an uncompressed format is being played by the media server 102 while the asset is being compressed, encrypted and transmitted wirelessly to the media client device 104. The process 500 begins with a step 502 that a media asset is selected from a media category for playing in the media server 102. Step 504 determines if the data for the media asset has been compressed to a desired format. If the step 504 decides that the data has not been compressed, the data for the media asset is compressed in step 506. The compressed data is encrypted based on the public/private key system in one implementation in step 508. The media server 102 receives a public key for the encryption. The data is processed and transmit wirelessly through the wireless interface in step 510.

There are different embodiments with regard to the transmitting of compressed asset to the client devices 104 in the present invention. According to one implementation, the compressed asset is transmitted only one time over the wireless link 106 in a playback cycle of the asset. According to another implementation, the compressed asset may be transmitted repeatedly until the playback cycle is completed. The media server 102 may be connected to multiple media client devices 104 via an ad hoc wireless network. A client device joining the network in a later time in comparison to other peer client devices may still receive the compressed media asset as long as the playback cycle is not completed.

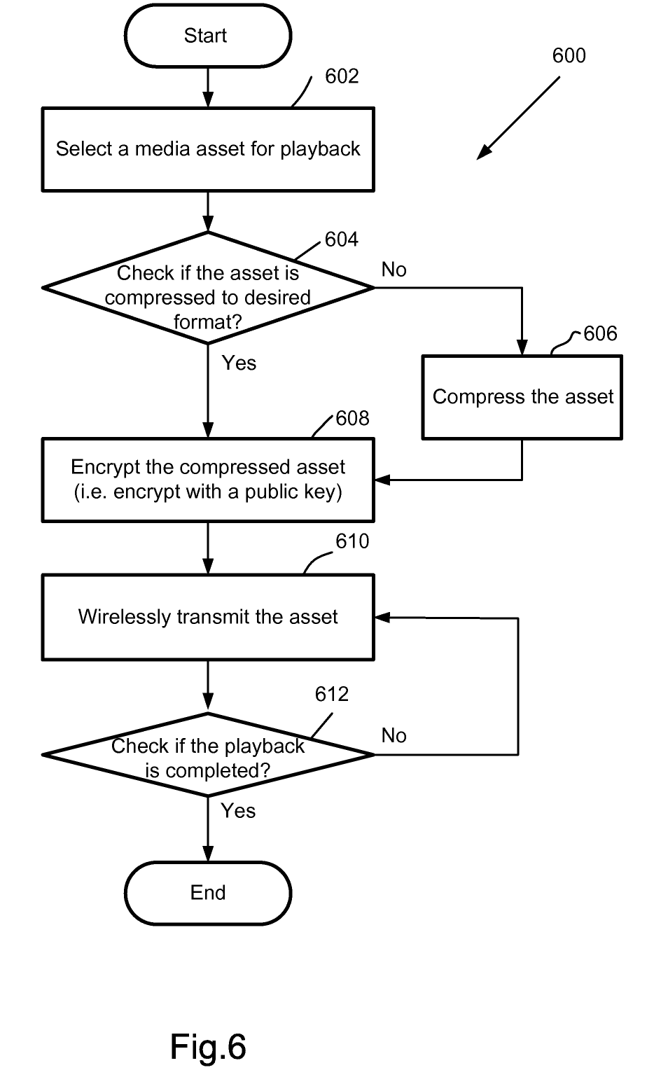

FIG. 6 shows a flow diagram of a process 600 that a compressed media asset is transmitted repeatedly when the uncompressed asset is being played by the media server 102. The process 600 begins with a step 602 that a media asset is selected from a media category for playing in the media server 102. Step 604 checks if the data representing the asset has been compressed to the desired format. If it has not been done, the compression is carried out in step 606. The compressed asset is encrypted (i.e. with a public key) in step 608. The encrypted asset is then transmitted via the wireless interface 106 in step 610. In step 612, the server 102 checks if the playback operation has been completed. The compressed and encrypted asset will be transmitted repeatedly until the playback operation is completed.

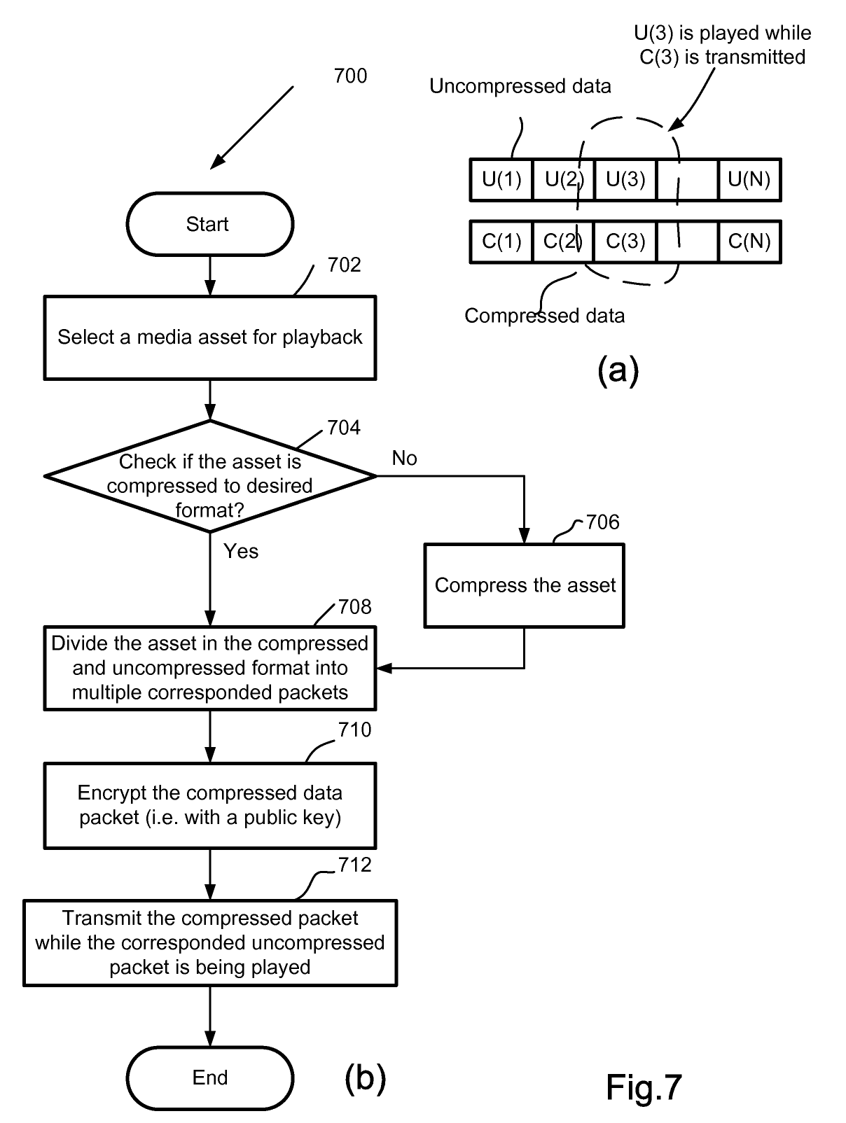

In yet another implementation, the media asset in compressed and compressed format may be divided into multiple data packets. As shown in FIG. 7a, each packet in compressed format corresponds to a packet in the uncompressed format. The data packets in the compressed format may be transmitted in sequential and in synchronization with the uncompressed data packets being played. The processor from the server monitors the progress of the playback operation. When a new data packet is played, a signal is sent to the processor. The processor initiates the operation of transmitting the corresponded data packet in the compressed form. Such an implementation may be useful for a long media asset such as long video programming.

FIG. 7b shows a flow diagram of a process 700 that a compressed media asset is transmitted based on data packets in synchronization with the media asset being played by the media server 102. The process 700 begins with a step 702 that a media asset is selected from a media category for playing in the media server 102. The format of the asset is checked in step 704. If it has not been compressed to a desired format, it will be compressed in step 706. The compressed and uncompressed asset is divided into multiple data packets in step 708. The compressed data packets are encrypted in step 710. The compressed packets are transmitted sequentially in step 712. The transmission of the packets is in synchronization with the asset being played. If for example a song is divided into the multiple packets, a specific packet is transmitted only if a corresponded uncompressed packet is being played by the media server 102. The compressed media asset may have been encrypted based on the public/private key system.

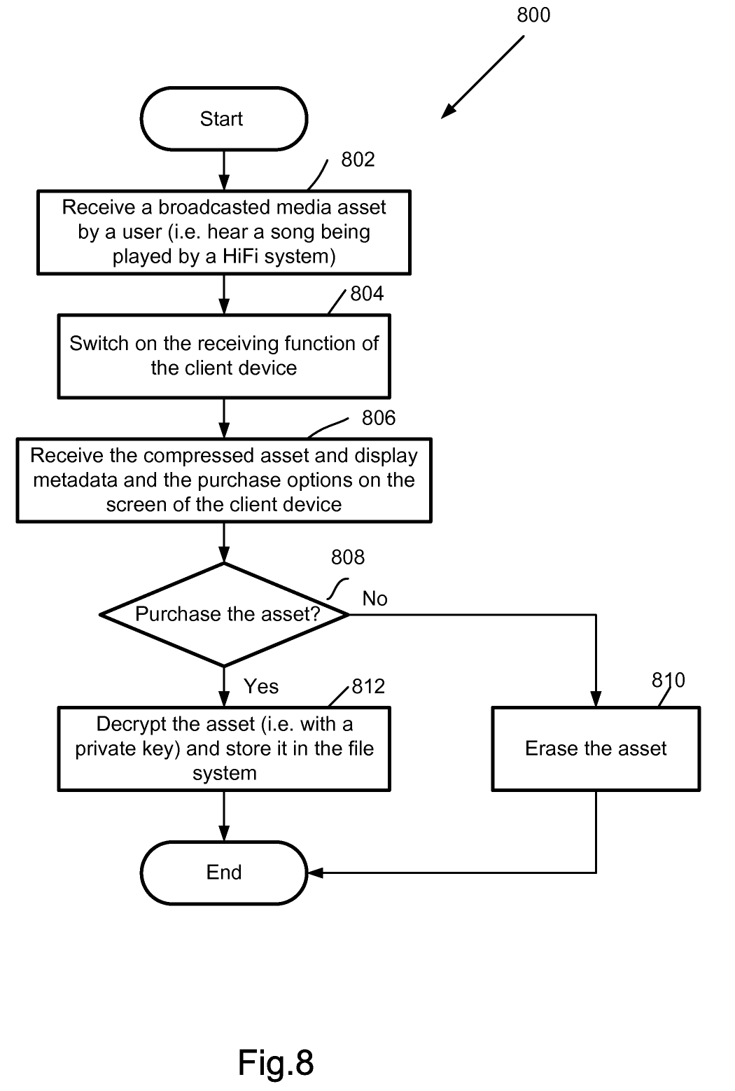

FIG. 8 shows a flow diagram of a process 800 that a compressed and encrypted media asset transmitted from the media server 102 is received by the media client device 104. The process 800 begins with a step 802 that a broadcasted media asset is received by a user in a conventional sense. For example, a user may hear a song being played by a HiFi audio system or a user may watch a video programming being shown on the TV terminal of a digital TV. The user may be intrigued by the content. The user then switches on a receiving function of the client device 104 in step 804. The client device is a handheld media player in one embodiment. The handheld media player receives the compressed asset in step 806 and displays the metadata of the asset on the display screen of the player. The metadata may include the author, the artist and the style of the asset. A purchase option with purchasing information may also be displayed on the screen of the player. The specific implementation has been illustrated in FIG. 4. If the handheld media player has been connected to the Internet, the user may carry out an on-line purchase immediately after he or she decides to purchase the asset in step 808. If the user decides not to purchase the asset, the received data is erased in step 810 and the displayed messages are also removed from the screen. If the user selects to purchase the asset, the data is then decrypted and is stored in the file system of the client device 104 for the further usages. If the media player has not been connected to the Internet, the received asset may be stored in the file storage system in the encrypted form. The user may purchase the asset when next time the player is connected to the Internet directly or via a server such as a personal computer.

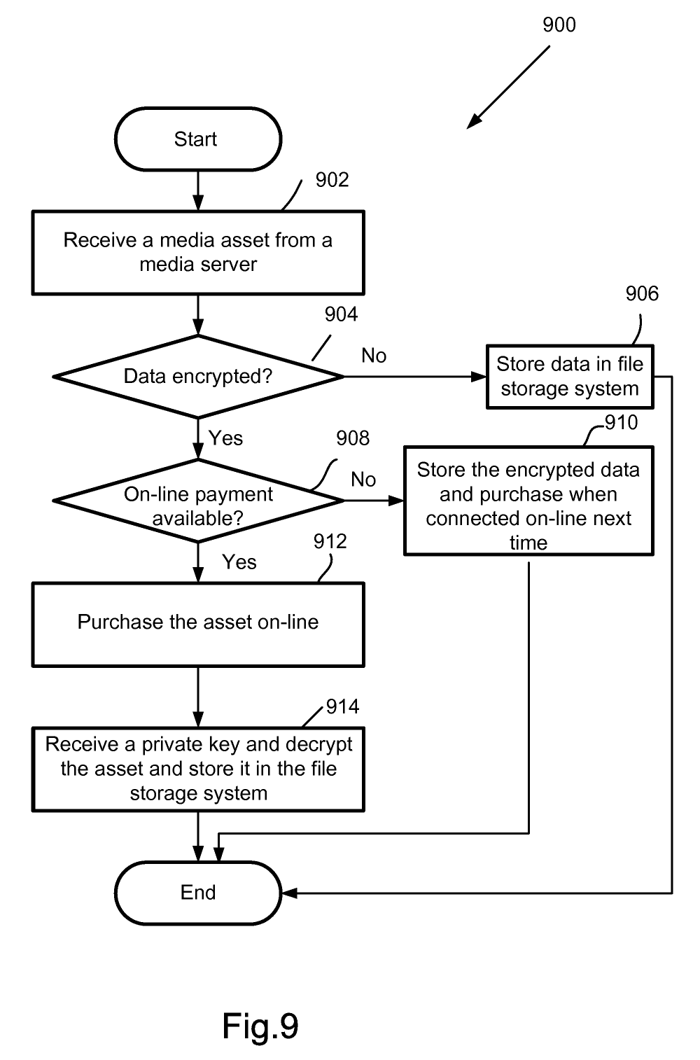

FIG. 9 is a flow diagram of the payment process 900 of a client device 104 after receiving a media asset from a media server 102. The process 900 begins with a step 902 that the client device 104 receives a media asset in the compressed format. The processor in the client device 104 checks in step 904 if the data is encrypted. If the data is not encrypted, the processor controls an operation to store the received asset into its file storage system in step 906. Otherwise, the processor checks if an on-line payment facility is available in step 908. If the on-line payment facility is not available, the processor controls an operation in step 910 that the encrypted asset is stored and the payment is going to be carried out when the client device is connected on-line next time and when the payment facility is available. The client device 104 completes the payment via on-line facility in step 912 if the on-line payment facility is indeed available. A private key is downloaded in step 914 from the on-line merchandiser to decrypt the encrypted data. The decrypted data is then stored in the file storage system under the control of the processor.

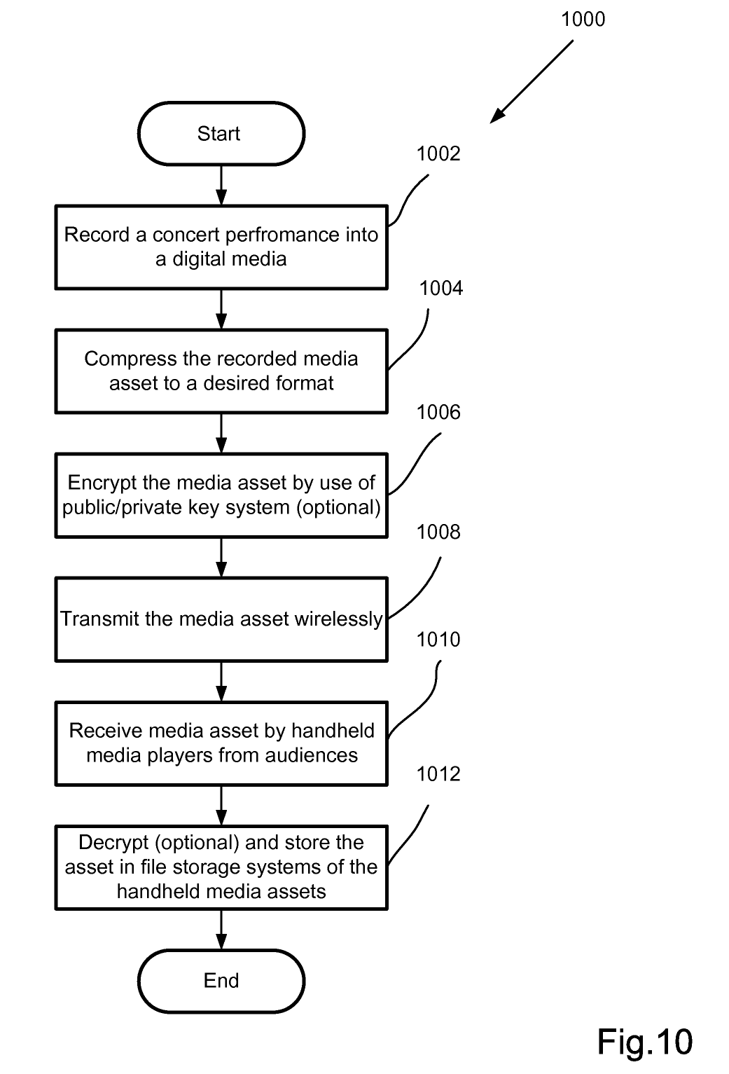

FIG. 10 shows a flow diagram of the operation of an embodiment of the present invention, wherein the media server is a concert media system 153 and the media client devices are handheld media players 164 as depicted in FIG. 1h. The system enables a performance is recorded and broadcasted to audiences of the concert. The audiences carrying handheld media players are able to receive the performance on real time base and store the asset in their handheld media players. The process 1000 begins with a step 1002 that a performance is recorded into a digital media such as a hard disk driver or a semiconductor flash memory. The asset is compressed to a desired format in step 1004. For example, a multi-media file is compressed to MP4 format. In step 1006, the compressed asset may be encrypted based on a public/private key system in a preferred embodiment. The step is optional. In step 1008, the compressed media asset is transmitted via the ad hoc wireless network formed by the concert media system 153 and the handheld media players 164. In step 1010, the handheld media players 164 receive the media asset. The asset may be decrypted (optional if it has been encrypted) and be stored in the file storage systems of the media player 164. The present embodiment allows the audiences of the concert receive a digital form of performance in their handheld media players for future usages.

While the invention has been disclosed with respect to a limited number of embodiments, numerous modifications and variations will be appreciated by those skilled in the art. It is intended that all such variations and modifications fall within the scope of the following claims:

1. A media delivery apparatus, comprising:
a media player for delivering a media asset based upon a data format;
a data compression unit for compressing the media asset; and
a wireless communication unit for transmitting the compressed media asset.

2. The media apparatus as recited in claim 1, further comprising a data encryption unit.

3. The media player as recited in claim 1, comprising:
a processor for controlling operation of the media delivery apparatus;
a file storage system for storing media assets;
a data processing unit for converting digital signals into analog signals; and
a power supply for providing power to the media delivery apparatus.

4. The wireless communication unit as recited in claim 1, including a device or a combination of devices from the following group:
a communication device providing a communication interface conforming to IEEE 802.11 type of standard and its amendments (Bluetooth);
a communication device providing a communication interface conforming to IEEE 802.11b or IEEE. 11 g type of standard and its amendments (WiFi);
a communication device providing a communication interface conforming to IEEE 802.15.4 type of standard and its amendments (Zigbee);
a communication device providing UWB (ultra wide band) communication interface conforming to IEEE 802.15.4a type of standard; and
a communication device providing a visible or an invisible optical communication interface.

5. The media player as recited in claim 1, further comprising:
one or a plurality of speakers; and/or
a video display device.

6. The media delivery apparatus as recited in claim 1, wherein the media player including a device selected from a group as follows:
a high fidelity audio system;
a television system with a set top box;
a vehicle media system;
a handheld media player;
an advertisement display panel;
a theater audio/video system; and
a concert audio/video recording and processing system.

7. A method of delivering a media asset from a media server to at least one media client device, comprising:
playing a media asset based upon a data format by employing the media server;
compressing the media asset to a desired format;
transmitting wirelessly the compressed media asset; and
receiving the compressed media asset by the media client device.

8. The method as recited in claim 7, wherein the media server including a device selected from a group as follows:
a high fidelity audio system;
a television system with a set top box;
a vehicle media system;
a handheld media player;
an advertisement display panel;
a theater audio/video system; and
a concert audio/video recording and processing system.

9. The method as recited in claim 7, wherein the media server further comprising:
a data compression unit;
a data encryption unit; and
a wireless communication unit.

10. The method as recited in claim 7, wherein the media server and the media client device are connectable through an visible or an invisible optical link or through a wireless communication interface which conforms to one of the following standards or its amendments:
IEEE 802.11 (Bluetooth);
IEEE 802.11b or 802.11g (WiFi);
IEEE 802.15.4 (Zigbee); and
IEEE 802.15.4a (UWB).

11. The method as recited in claim 7, wherein the media client device including a device selected from a group as follows:
a handheld media player;
a high fidelity audio system; and
a general purpose computer.

12. The method as recited in claim 7, wherein said operation of transmitting including transmitting the compressed media asset repeatedly while the media asset is being played by the media server.

13. The method as recited in claim 7, wherein said operation of transmitting including dividing the compressed and uncompressed media asset into a plurality of data packets and transmitting the compressed data packets sequentially in synchronization of said operation of playing the uncompressed data packets.

14. A method of media client devices receiving a compressed media asset transmitted wirelessly from a media server, wherein the media client device and the media server forming a whole or a part of wireless network, the method comprising:
establishing a wireless communication network between the media server and the media client devices;
receiving a media asset in a compressed format by the client devices from the server while the media asset in an uncompressed format being played by the server.

15. The method as recited in claim 14, wherein the media asset is generated through a concert media recording and processing system during a live performance.

16. The method as recited in claim 14, further comprising:
encrypting the compressed media asset by the media server;
displaying a message related to the received media asset on a display screen of the client device;
purchasing the media asset through an facility enabled by a communication network;
decrypting the received asset; and
storing the media asset in a file storage system of the media client device.

17. The method as recited in claim 16, wherein the operation of encrypting and decrypting is based on a public and private key system and a public key is distributed to the media server and a private key is distributed to the media client devices.

18. The method as recited in claim 14, wherein the media client devices including at least a device selected from a group as follows:
a handheld media player;
a high fidelity audio system; and
a general purpose computer.

19. The method as recited in claim 14, wherein the method further including switching on a function of the media client devices for receiving the media asset wirelessly through actuating a component of a user input device.

20. The method as recited in claim 14, wherein the operation of transmitting the compressed media asset including:
transmitting repeatedly the compressed media asset during a playback cycle of the uncompressed asset by the media server; or
dividing the compressed and uncompressed media asset into a plurality of data packets and transmitting the compressed data packets in sequential in synchronization with the operation of playing the uncompressed data packets by the server.
